(19) United States
(12) Patent Application Publication
(10) Pub. No.: US 2018/0108235 A1
(43) Pub. Date: Apr. 19, 2018

(54) Personal Safety Monitoring

(71) Applicant: Mark H. Ginocchio, St. Petersburg Beach, FL (US)

(72) Inventor: Mark H. Ginocchio, St. Petersburg Beach, FL (US)

(21) Appl. No.: 15/784,832

(22) Filed: Oct. 16, 2017

Related U.S. Application Data
(60) Provisional application No. 62/408,486, filed on Oct. 14, 2016.

(51) Int. Cl. G08B 21/02; H04W 8/00; H04W 4/02

(52) U.S. Cl. CPC G08B 21/02; H04W 4/008; H04W 4/02; H04W 8/005

(57) ABSTRACT

A method of monitoring and a monitoring device for detecting notable behaviors of other persons, by monitoring for and capturing unique identification information for persons, such as biometric (e.g., facial recognition) data or identifiers broadcast from mobile devices. Records of detected unique identification information are stored in memory with location, day and/or time of day, so that newly detected identification information can be compared to that previously stored data and location, day and/or time. Alarms may be triggered based upon the match, or lack of a match, of a current location, day and/or time with the previously stored data for detected identification information.

### RELATED APPLICATIONS

This application is a U.S. non-provisional application claiming priority to provisional application U.S. Ser. No. 62/408,486 filed Oct. 14, 2016, which is incorporated herein in its entirety.

### TECHNICAL FIELD

This application generally relates to systems and methods for monitoring the safety of a person or area via detection of mobile devices of others.

### BACKGROUND OF THE INVENTION

Since their inception, electronics have been applied in various ways monitoring areas and persons for the purposes of personal safety or property security. Electronic systems have been used in personal homes and protected business locations to monitor motion and the opening and closing of doors. Electronic systems have been placed in outdoor locations to detect motion of persons into protected areas. Finally, with the advent of personal mobile devices such as laptop and palmtop computers, personal digital assistants, cellular phones, smart phones, tablet computers, and the like, electronic systems have been developed to work with those devices to monitor their movements, and applications have been developed for those devices to monitor surrounding areas, often with the use of connected peripheral equipment such as sensors and cameras.

Smartphone applications (apps) have been developed to interact directly with the smartphone user to enhance safety. For example, several applications exist which can be triggered to alert a remote person of the smartphone user's location, or to issue an alert immediately or after a short period of time unless deactivated.

There have been studies and proposals suggesting that mobile phone transmissions could be tracked in various ways. For example the white paper published by the Electronic Frontier Foundation at https://ssd.eff.org/en/module/problem-mobile-phones, phones, entitled “The Problem with Mobile Phones” notes that mobile phones deliver a number of transmissions which can be monitored and which have the effect of compromising personal privacy and security. The paper notes a number of privacy compromises, the first of which is the possibility of tracking the location of the user via cell phone towers, IMSI catchers or even Wi-Fi or Bluetooth® radios. An example of an IMSI—IMEI—TMSI catcher is currently available for sale from Ability Computers & Software Industries Ltd. Of 14 Yad Harutzim Street, Tel Aviv Israel. Methods for capturing data by such devices are described, for example, in PCT Publication WO 2007010223 A1, which is hereby incorporated by reference herein in its entirety.

While the capture of IMSI—IMEI—TMSI codes (which will be generally referenced herein as IMSI codes) from mobile telephones is a security and privacy concern, in some cases the trackability of a phone can prove useful, as elaborated by U.S. Patent Publication 2012/0064855 which describes a monitoring device usable by first responders to search for trapped people in an emergency area by monitoring for mobile telephone transmissions. Furthermore, there have been proposals that the ongoing transmissions made by mobile devices could aid in developing social connections; for example, U.S. Pat. No. 8,355,473 describes a communication device that determines whether there is a social interaction between a user of the device and a user of a second device, and if so, the communication device stores identification information of the second device to track that social interaction. Each of these prior publications is incorporated herein by reference in its entirety.

### SUMMARY OF THE INVENTION

The present invention takes a new approach which is based upon the ability to monitor, with a monitoring device, the presence of other persons carrying a mobile device. Specifically, the invention uses the monitoring device to monitor for unique identification information of one or more persons, such as broadcasted identifiers of one or more monitored mobile devices, or biometric information, and store records associating the unique identification information with a current location, day and/or time of day. This stored data permits the monitoring device to evaluate whether the detection of a person is notable, based upon the location, day and/or time of that detection, and whether or not the person has previously been detected at the same or a different location, day or time. Based upon logic applied to the new detection and any previous detections, the monitoring device may trigger an alarm based upon the match, or lack of a match.

In specific embodiments the monitoring device may be a smartphone running suitable application software, or a smartphone and connected IMEI catcher working with the smartphone. An entirely standalone implementation of the monitoring device is also contemplated, which may be used as a mobile device, or be stationed in a fixed location.

The monitoring device may use a GPS receiver or other geospatial locating means for determining a current location of the monitoring device. Further, the monitoring device may comprise a Bluetooth® radio capturing a Bluetooth® MAC address for a Bluetooth® enabled device near to the monitoring device. Also, the monitoring device may comprise a WiFi radio, the WiFi radio capturing a WiFi MAC address for a WiFi enabled device near to the monitoring device. The monitoring device may comprise a near field communication radio, the near field communication radio capturing a NFC MAC address for a NFC enabled device near to the monitoring device. Finally, the monitoring device may be a camera with face or body recognition software for detecting persons.

In disclosed embodiments, the processor logic of the monitoring device may trigger an alarm in several different situations:

A new person alarm may be triggered when there is no previously stored data for the unique identification information of a detected person and/or mobile device. This may be done in all cases or only when the current location is designated to generate alarms upon detection of all new monitored persons and/or mobile devices.

A frequent detection alarm may be triggered when the previously stored data for the unique identification information of a monitored person and/or mobile device indicates greater than a threshold number of detections of the monitored person and/or mobile device. This may be done in all cases, or only if the current location and/or the unique identification information of the monitored person and/or mobile device are designated to generate alarms upon greater than a threshold number of detections of the monitored person and/or mobile device.

A new location alarm may be triggered when there is no previously stored data for the unique identification information of a monitored person and/or mobile device at a current location. This may be done in all cases, or only if the current location and/or the unique identification information of the monitored person and/or mobile device are designated to generate alarms upon detection of the monitored person and/or mobile device at a new location.

A new day/time alarm may be triggered when there is no previously stored data for the unique identification information of a monitored person and/or mobile device for a current day/time. This may be done in all cases, or only if the current location or the unique identification information of the monitored person and/or mobile device are designated to generate alarms upon detection of the monitored person and/or mobile device at a new day/time.

The use of the frequency of detection, and location, day and time as criteria in monitoring for third persons and third party mobile devices, enables the present invention to enhance the quality of monitoring and detect potentially unsafe scenarios, with minimal user involvement, in a manner that is more finely tuned than has been done in the past.

### BRIEF DESCRIPTION OF THE DRAWINGS

The present disclosure will be more readily understood from a detailed description of some example embodiments taken in conjunction with the following figures:

FIG. 1 is a diagram illustrating the movements of persons bearing mobile devices through various geographic locations, and meeting other persons at those geographic locations;

FIG. 2 is a block diagram illustrating the internal operating parts of a device using principles of the present invention, including a processor and peripheral systems within the device or working in conjunction with the device to implement principles of the present invention;

FIG. 3 is a process diagram illustrating an exemplary monitoring process implemented by the device of FIG. 2, to develop data and to provide warnings of events worthy of note based upon the developed data;

FIG. 4 is a data structure diagram illustrating data gathered on mobile devices of other persons;

FIG. 4A is a diagram illustrating an exemplary location classification and geocoordinate information table used for locations indexed in the location records 68 of FIG. 4;

FIG. 4B is diagram illustrating an exemplary manner in which time of day may be indexed in the location records 68 of FIG. 4; and

FIG. 4C is a diagram illustrating an exemplary manner in which days are indexed in the location records 68 of FIG. 4.

### DETAILED DESCRIPTION

Various non-limiting embodiments of the present disclosure will now be described to provide an overall understanding of the principles of the structure, function, and use of the mobile device monitoring systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The specific embodiments disclosed below are generally directed to monitoring for wireless transmissions of mobile devices carried by persons, and the configuration of mobile devices or stationary devices to detect the unique identifying information, e.g. identifying codes, that are thus transmitted. The monitoring device may then store data, and/or provide an alert in response to what has been detected.

In alternate embodiments, identical concepts for tracking and evaluating detections may be may be reapplied to monitoring for persons as such rather than devices carried by persons; in these embodiments the invention would use the detection of biometric information (face and or body information) of persons, and applying tracking methods to the uniquely identifying biometric information for persons captured in this manner.

In the specific disclosed embodiments the tracking concepts disclosed herein are directed to tracking cellular telephones and Bluetooth® devices. However, the principles of the present invention are not so limited. Principles of the present invention may be used to track mobile devices other than cellular telephones and the like; for example, wristbands or clothing attachments may be attached to persons to be monitored, e.g., family members, children, or persons under house arrest or restraining orders, to enable tracking of those persons in accordance with principles of the present invention.

In various embodiments, the monitoring device may detect the transmissions through generally passive detection processes. In other words, a user of does not necessarily have to routinely initiate or activate the detection process. Instead, the detection process may be a background routine that operates in the random access memory (RAM) of a device, for example. The background routine may periodically, or at least routinely, query signals received or generated by various on-board or connected wireless components in order to detect if a wireless transmission is present. These queries may be performed without additional input from the user. Components queried by the detection process may include, without limitation, on-board Bluetooth®, Wi-Fi, NFC or cellular radios, IMEI catching systems, or connected peripherals containing the same.

In some embodiments, the action of the monitoring device may be a function of where the device is geographically located. In other words, a monitoring device in a private home that passively detects a wireless transmission may generate an alert, and/or request additional information from the user, whereas a monitoring device in a public place that detects the same transmission may not issue the same alert, or may issue no alert at all. Additionally, the behavior of the monitoring device may depend on other information, such as whether the device has detected the same monitoring device previously, and whether that detection was at the same or a similar location, day or time, and so forth. User preferences and user-supplied data may be part of this determination.

The information stored by the monitoring device may be stored, arranged, and viewed in any suitable configuration. The information may be viewed and edited by a user at the time of receipt or at a later point in time. As is to be appreciated, the data can be stored and sorted in any suitable hierarchy or schema.

In some embodiments, detections of monitored devices may be compared to certain parameters or thresholds. The thresholds may relate to a total number of times the monitored device has been detected, the number of times detected at a given geographic location, and so forth. These thresholds may determine whether an alert is provided to the user by the monitoring device. In one embodiment, upon receiving an alert, the user can then use an application on the monitoring device to view the content received.

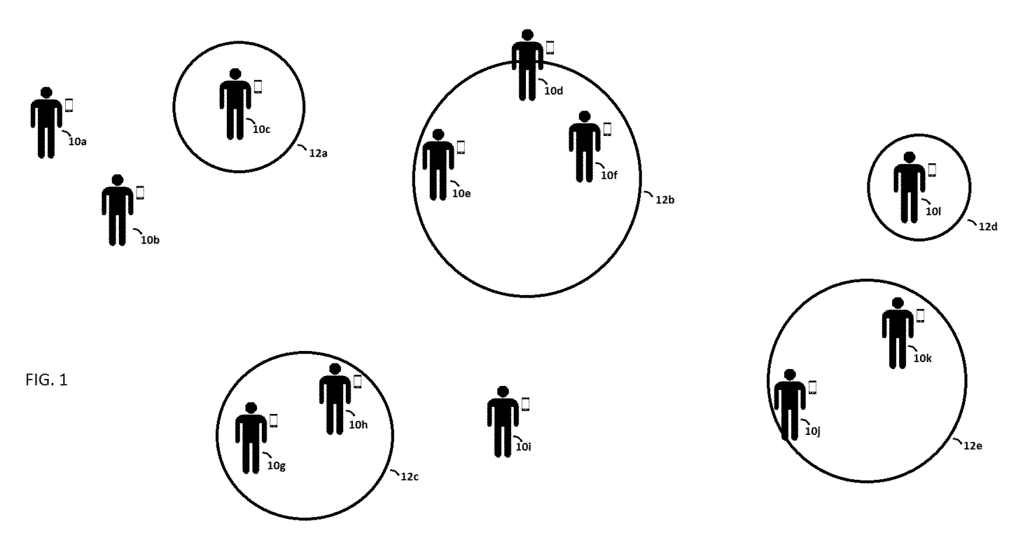

Turning now to the Figures, wherein like numbers indicate like features through the views, FIG. 1 illustrates a variety of exemplary social/spatial environments in which the monitoring systems and processes described herein may be implemented to flag the proximity of other persons through a mobile device. As shown in FIG. 1, mobile device users, indicated at 10a-10k, generally move between a number of different social environments and interact with buildings, persons and mobile device users within and between these environments. These environments include private homes, represented by location circles 12a and 12d, typically having a limited number of potential interactions; to more populated environments such as offices, restaurants and/or other public places, represented by location circles 12b and 12c, having the potential for large numbers of interactions. Additionally, interactions with other persons can occur in outdoor spaces including parks and other recreation areas, represented by location circle 12e, in which the number of persons present at any given time can vary significantly. Each of these locations is represented as a circular range, wherein the monitoring device location would be roughly in the center and the radius would comprise the extent of the monitored location. Each of these different environments present opportunities to encounter with known and unknown persons with whom a person may desire to initiate a social interaction or who, conversely, may present a security threat. The process described below monitors the presence of other third party mobile device users in these different types of environments. The process provides for detecting and identifying known persons as well as flagging the proximity of unknown or threatening persons at particular locations, days and/or times.

In each of the environments depicted in FIG. 1, individual mobile devices broadcast unique identification information, such as a MAC address or IMEI, within a proximity zone in three-dimensional space. A range of zones can exist, with the number and types of interactions occurring within a zone depending upon the type of social environment. The distance of a mobile device can potentially be determined from the signal characteristics, as is shown in US Patent Publication 2014/0111380, which is incorporated by reference herein in its entirety.

The need to flag the proximity of notable persons may vary with the social setting. For example, in a personal and generally private location, such as a private home, there would likely be frequent detections of a small number of mobile device addresses, with the detected mobile devices belonging to family members or close friends. Accordingly, it may be desirable to generate an alert at this location on detection of any new mobile device. In a more public place, wherein potentially large numbers of new mobile devices will be detected, the need to generate an alert on detection of a new mobile device may be considerably lower. These environments are just a few examples of possible scenarios for the monitoring systems and methods described herein. It should be understood that the number and locations of monitored mobile devices will vary across different environments. Thus, the systems and methods described herein are not to be limited by the number or location of monitoring or monitored devices.

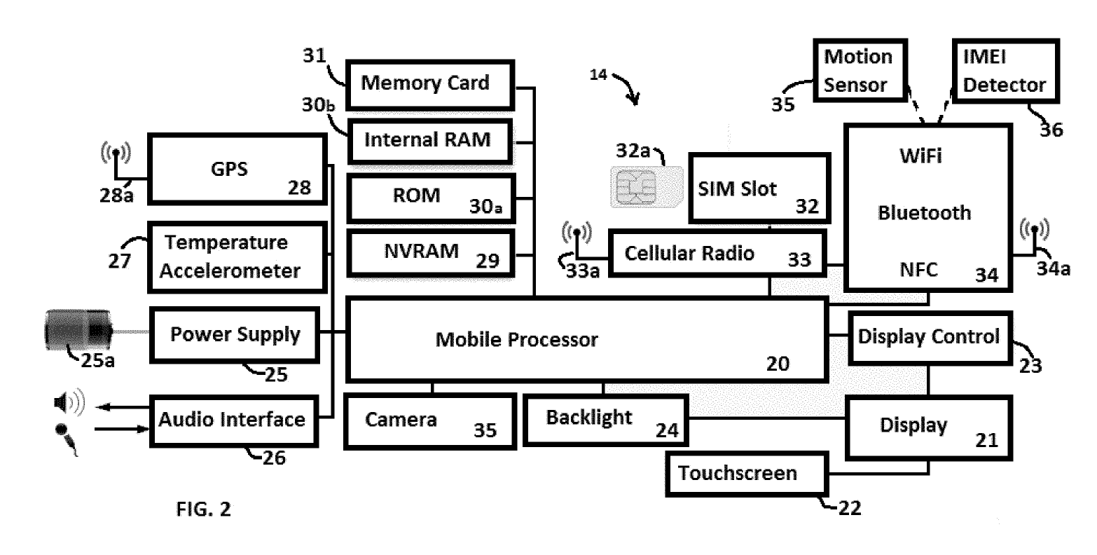

FIG. 2 is a block diagram depiction of an example embodiment of the internal operating parts of a monitoring device 14 through which the methods and systems described herein may be implemented. Device 14 may, for example, be a conventional smartphone having a processor 20, a display 21, and/or a touchscreen 22. A display control 23 and a backlight driver 24 may be provided for operating the display 21 and/or touchscreen 22. Processor 20 is connected to a power supply 25 which is in turn connected to a power source, such as a battery 25a. Device 14 may further include an audio interface 26 for receiving and emitting audible signals, temperature and accelerometer sensors 27, and a global positioning system (GPS) 28 with associated antenna 28a. Device 14 further comprises a memory, components of which may include a NVRAM 29, a ROM 30a, an internal RAM 30b, and/or a memory card 31. For typical embodiments which use Internet access for reporting of alarms and events, device 14 will typically include a network interface; in the illustrated embodiment this network interface is a SIM slot 32 for receipt of a SIM card 32a for enabling functioning of the device in a cellular communication system. A cellular radio 33 and antenna 33a are provided for enabling the device to transmit and receive radio signals over a cellular network. In alternate embodiments Internet access could be achieved with other wireless methods such as WiFi, Bluetooth® or Zigbee, or with wired network communication such as via an Ethernet interface.

Device 14 typically includes a module 34 and antenna 34a for transmitting and receiving WiFi, Bluetooth®, NFC and/or other short range wireless radio communication signals, either for Internet communication for the processor 20, or for detection of WiFi, Bluetooth®, NFC or other wireless transmissions of other mobile devices for the purposes of the present invention.

The device further includes a motion sensor 35 that may be placed on a door or other access point to detect moving objects in an area. Upon sensing a person, the motion sensor 35 may transmit a signal to the monitoring device 14 in order to provide a possible alert. An IMEI detector 36 may also be used in conjunction with the monitoring device 14. IMEI detector 36 detects wireless transmissions of unique IMEI codes from mobile phones, or devices equipped with a built-in mobile phone, and transmits the codes to device 14. Device 14 analyzes captured IMEI codes and determines whether to generate an alert, as elaborated below.

It will be appreciated that the various components of FIG. 2 may be internal operating parts within a housing, or peripheral components connected (either wired or wirelessly) to the housing that includes processor 20. For example, IMEI detector 36 and motion sensor 35 may be peripheral components connected wirelessly via module 34 processor 20, so that they may capture activity of persons in proximity to the monitoring device, and communicate the detection to the device. In some embodiments, motion sensor 35 and/or IMEI detector 36 may be incorporated into the monitoring device 14 rather than being a peripheral device.

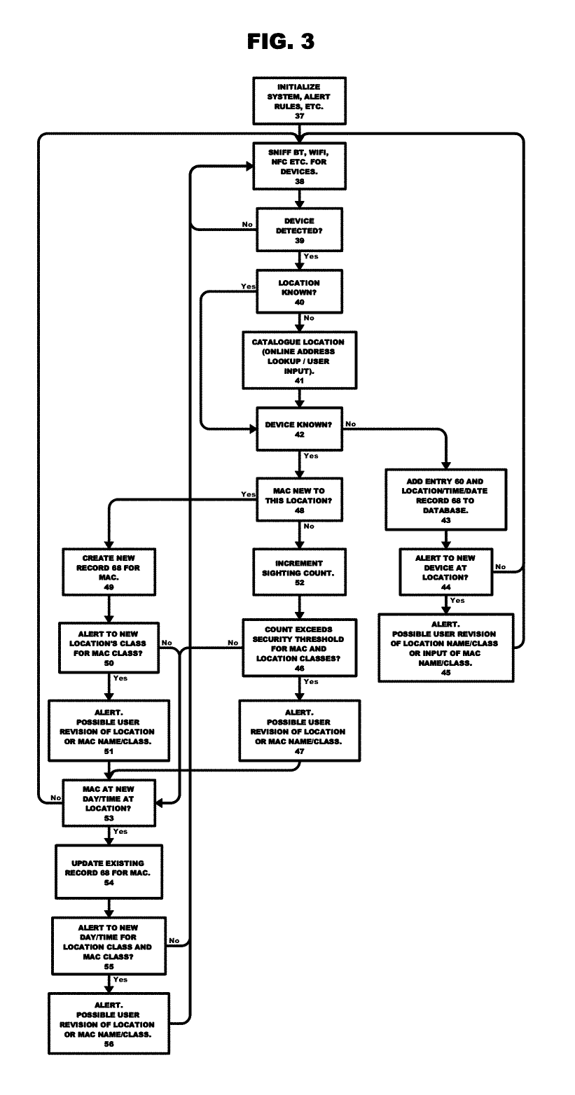

FIG. 3 shows one example of a monitoring process of FIG. 3 implemented by processor 20 in a monitoring device 14. In the example, processor 20 includes logic, which may be in the form of application software loaded onto device 14, for implementing the monitoring process of FIG. 3. As shown in FIG. 3, monitoring device 14 is initialized at the beginning of a monitoring process. The initialization (step 37) typically occurs at first use of the monitoring process, but the process may be reinitialized at a later time in order to change rules and settings. The initialization step can include setting alert threshold levels, designating locations, days, or times at which to provide alerts or to restrict alerts, and other alert rules. After initialization, the process enters a monitoring mode to look for, or sniff, broadcast signals from other mobile devices (step 38). These signals include, but are not limited to, Bluetooth®, Wi-Fi, NFC transmissions and/or cellular radio signals. Device 14 may, e.g., monitor for and captures the wireless broadcast signals through module 34. The captured signals are evaluated by logic in processor 20 to detect unique identification codes, which can include MAC addresses, from monitored mobile devices.

When a device (and MAC address, IMEI, etc.) is detected (step 39), in one embodiment, the processor 20 may take a variety of actions based upon the location. In the event that the processor 20 is embodied in a mobile device, the processor may receive and evaluates current location coordinates from GPS 28 to determine whether the current location of the device and also determine if that location is a known location (step 40). Specifically, for this step, the current location coordinates may be compared by processor 20 with a table of geocoordinate information of known locations stored in memory 31.

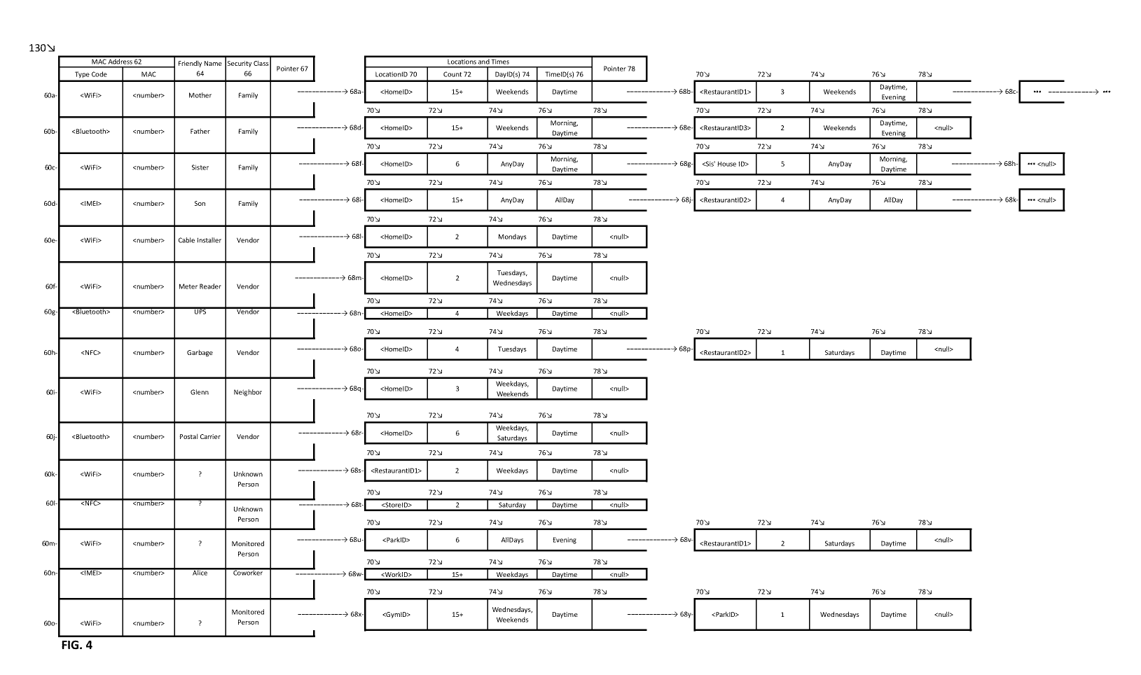

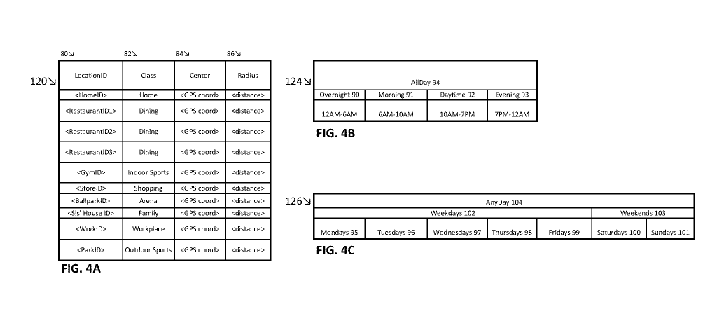

FIG. 4A depicts one example of a table of geocoordinate data 120 which may be used to evaluate current location coordinates. In the exemplary table 120, the GPS coordinates for a location are identified by fields 84 and 86. A field 84 identifies a center point and a field 86 provides a radius value for the associated GPS coordinates. The radius value defines a circle, such as 12a-12e in FIG. 1, which will be considered a location for purposes of operations of the monitoring device 14. The monitoring process of FIG. 3 may determine if a location is known (step 40, FIG. 3) by comparing the current GPS coordinates with each of the GPS coordinate entries in field 84. If the GPS coordinates at the current location of monitoring device 14 are determined to be within an area defined by an entry 80, then the current location of the monitoring device 14 is treated as a known location. The geocoordinate table 120 also may include a location identification field 80 and a location classification field 82 for each of the known GPS locations. Location identification and/or classification data from fields 80 and 82 may be displayed by monitoring device 14 when an identification code is detected by the device at a known location and/or when an alert is provided, as is discussed further below.

If the GPS coordinates for the current location at which a mobile device is detected are not already stored in the geocoordinate table 120, then the current location is an unknown location for the monitoring device 14. For an unknown location, the device 14 will index the location. For example the device may calculate a street address and radius for the location from current GPS coordinates, and catalogue the street address and radius in the geocoordinate table 120 (step 41). A current street address and radius can be determined manually by the user, determined in a hybrid automatic/manual process using a mapping database, or can be determined automatically by application software. In an automated process, the current GPS coordinates are input to a mapping database such as Google Maps. Using the GPS coordinates, the mapping database identifies the nearest GPS location that is registered in the database with an associated street address. The returned street address can be automatically assigned as the Location ID for the current location. In a hybrid process, a sampling of a number of the nearest street addresses can be presented to the user for verification of the current location. Once a current street address is determined, the text for the street address may be stored as the location ID in field 80 of geocoordinate table 120.

Using the current street address, step 41 can determine a radius for the current location by identifying the next nearest GPS locations associated with neighboring street addresses. The GPS coordinates for the current street address are then designated as the center, and the distance or average distance to the next nearest GPS location(s) calculated as the radius. As part of adding the current location as a new location ID in table 120, the process may prompt the user to assign a name or classification to the current location. An assigned name will be catalogued as the location ID in field 80. An assigned classification will be catalogued in field 82. As an alternative to the user assigning a name, the application may perform an online address search to locate a name for the current location. If a name is assigned or rendered through the online search, the name is stored with the current GPS coordinates in the geocoordinate table in field 80 (step 41). In addition, the mapping database may associate a business name with the street address, and the business name may be recorded in field 80.

After evaluating the location of the detected mobile device, and cataloguing the location if new, in step 42, the process of FIG. 3 evaluates the current detected device's MAC address, or IMEI or other identifying code, to determine whether or not the device is known, i.e. has been previously detected by the monitoring device 14. To evaluate the device, processor 20 compares the current detected device address with a table of prior detected addresses 130. FIG. 4 illustrates one example of a data structure which includes a table 130 of known device identifiers (MAC addresses, IMEI etc.) (field 62) that can be used to compare the data from the currently detected device with known devices. Additionally, the address table 130 includes a Name field 64 to enable the user to associate a familiar name or label with a device, and a Security Class field 66 to enable the user to designate a security classification for a device. The data structure 130 also includes a pointer 67 to a linked list of one or more records 68, each documenting a location, day, and time of day of detection for the detected device. Each record 68 indicates a location, and the day and time of day at that location where the device was detected. Each location is associated with a separate data record linked back to the device in the address table 130.

If the device is known at step 42, i.e. the detected MAC address/IMEI already exists in the address table 130; then the process of FIG. 3 evaluates data records linked to the device to determine if the location ID (from table 120) for the current location of the monitoring device 14 matches the location ID in any of the data records 68 linked to that device (step 48). If the current location ID matches a location ID in an existing data record 68 linked to the device, then the device has been previously detected at the current location. Logic in processor 20 then increments the detection counter in field 72 of the data record 68 with the matching location ID (step 52).

After incrementing the counter in field 72, the process of FIG. 3 compares the new count with a predetermined threshold number of detections (step 46). The threshold number of detections may be a predetermined number of detections of a device which, when reached, triggers an alert (step 47). The threshold may be different depending upon the location, day of the week, or time of day that the device is detected, so that an alert is triggered only when desired by the user. For example, a frequent detection alert may be triggered when the device detections exceed the threshold in any location, or only if the threshold is exceeded at certain designated locations. Additionally, an alert may be triggered only when the threshold is exceeded on certain days of the week, or at certain times of the day. As mentioned above, the threshold level settings may be established during the initialization process in step 37 and stored in memory 31 of the monitoring device 14. Processor logic triggers a frequent detection alarm or alert when a threshold level designated for a current location, a unique identification code, or both is met or exceeded. The alert may be audible, visual, or both; and may include a display or an audio broadcast of the name or security classification data from the address table fields 64 and 68. Upon issuance of an alert, the user may be prompted to revise the location name 80 or location classification 82 for the location, or to add or change a name 64 or security classification 66 for the device. For example, upon receiving an alert at home, a user may update the security class (field 66) of the entry in table 130 for the device, to identify the device as belonging to a family member. Likewise, the user may update the classification associated with the current location ID (field 82, FIG. 4A) to specify that the location is a home location. Following any changes to names and/or classifications, the user may also update the alert rules, e.g., to not issue alerts for devices identified as family, or not issue alerts for family devices detected when the current location is classified as home.

If the device detection count is less than the threshold in step 46, or after any triggered alert in step 47, then the process of FIG. 3 proceeds to step 53.

Returning to step 48, if the detected device is new to the current location (i.e., there is no record 68 for the current location associated with the device), the process of FIG. 3 creates a new data record 68 in memory 31 for the Device (step 49). The new data record 68 includes the current location ID in Location ID field 70, as well as the day (field 74) and time (field 76) of the detection in the new data record.

In storing the time of day for the new data record 68, the process of FIG. 3 may use a time of day index 124 shown in FIG. 4B. Index 124 classifies a 24 hour day into four distinct time periods. Index 124 simplifies the designation of the time of device detection, by limiting the designation to a few select time periods. In selecting the day of the week to enter in the new data record 68, process of FIG. 3 may reference a days of the week index 126 shown in FIG. 4C. Index 126 enables the detection day to be identified either by a specific day based on a seven day week, as in fields 95-101, or classified more generally as either a weekday 102 or a weekend 103, or “any day” 104.

When a new record 68 is created for a device, the specific day and time of day will be stored in that record. However, as will be elaborated below, as detections of a device at a given location reoccur, the detection day and time information may be expanded to reflect the days and times of detection (in some cases with an accompanying alert to the user). Ultimately, the time of day field 76 and day of detection field 74 in data record 68 may be populated with a generic “all day” 92 value and generic “any day” value 104, for devices that are frequently detected at the same location, such as family members at a home location.

When a new record 68 is created, a count field 72 in the new data record 68 will be initialized with a count of one. Processor 20 further assigns a pointer to the new data record 68 into the existing data structures in the device memory; this pointer is stored in the field 67 of the referencing entry 60 in address table 130 (if the data record is the first data record associated with the device), or in the field 78 of the last data record 68 in the linked list attached to the device record 60. Accordingly, device records 60 will accumulate a linked list of location records 68, as shown in FIG. 4.

After creating a new data record 68, a determination is made whether to issue an alert, to advise the user that a known device has been detected at a new location (step 50). If the application was initialized to issue an alert for detection of a known device at a new location, then processor 20 is directed to trigger an alert (step 51). Note that the determination of whether to issue an alert to a known device at a new location may be based on the classification of the device and location. A device classified as “family” may be handled differently than a device classified as unknown (e.g., a “family” device may not trigger an alert at home, but will at a large public space, and the opposite may be true of an “unknown” device). Devices classified as “Monitored person” could be handled yet differently, e.g., issue alerts at all times. Following issuance of the alert, the user may be prompted to revise the location name 80 or classification 82 for the current location in the table 120. Similarly, the user may be prompted to add or change a name 64 or security class 66 for the device in the address table 130. Following input and storage of any user revisions to names, classifications, and alert statuses, the process of FIG. 3 moves to step 53.

At step 53, a determination is made as to whether the device is being detected at a new day of the week and/or at a new time of day for the current location. Processor 20 determines whether the day of the week and/or time of day are new by referencing each of the Time ID fields 76 and Day ID fields 74 in data records 68 for the detected device at the previously determined current location ID. If the device has previously been detected on the same day and time, the process returns to monitoring for devices at step 38. If the device is detected at a new day of the week, then processor 20 updates the data record 68 for the device and current location to reflect the new day of the week in field 74. This update could include changing field 74 to reflect different labels from days of the index 126. For example, if the device has been detected at the current location on both a Saturday and a Sunday, field 74 may be updated to include the label “Weekends” 103. If the device is detected at a new time of day, then processor 20 updates the data record 68 for the device and current location, using time of day index 124, to reflect the new time of day in field 76. As shown in FIG. 4, multiple data records 68 can be stored for the same device, with each of the records indicating a different location and the day(s), or time(s) that the device was detected. Each of the data records 68 for a specific device are linked back to the device record 60.

After a data record 68 is updated with the new day and/or time (step 54), the application determines whether to issue an alert for the detection of the known device at a new day and/or a new time for the current location (step 55). If the application has been initialized to trigger an alert for the detection of a known device at any new day and/or new time, or at the specific day and/or time of the current device, then processor 20 triggers an alert (step 56). It will be appreciated that the decision of whether to alert may be based on the classification of the location or device. For example, at a “home” class location any device detected during overnight hours may trigger an alert, whereas in a public location only unknown devices detected during overnight hours may trigger an alert. Following possible issuance of any alerts in step 56, the user may be prompted with the details of the alert, including the location name, device name and time of day, and in response the user may revise the location name 80 or classification 82 associated with the device, or to add or change a name 64 or security class 66 for the current device, or to change the conditions under which an alert is triggered. Following input and storage of any user revisions, the process returns to step 38 to continue monitoring for and capturing additional devices.

Returning now to step 42, if a device is detected and its MAC address or IMEI or other identifying information is not found in any of the data records 60 of data structure 130, then the device is a new, unknown device. In this case, the application adds the new device as a new record 60 in address table 130 (step 43). As part of adding the device to the address table 130, the process of FIG. 3 may prompt the user to assign a name for the device, to be stored in field 64 of the table. In addition, the user may be prompted to assign a security class for the device. The security class is stored in field 66 of the address table. The user may be prompted to select a name or security class from an index of names or security classes set up by the user during the initialization process in step 37, or the user may select from a predetermined list of names or security classifications that are predefined within the application. Alternatively, process of FIG. 3 may use the MAC or IMEI for the device to perform an online address search to locate a user name for the detected mobile device, or at least a mobile carrier name (e.g., “unknown AT&T subscriber”). If a name is assigned or rendered through the online search, the name is stored in the data record 60, field 64 (step 43). In addition to the record 60, a new record 68 is created and linked to the record 60 in step 43. The new record 68 includes the location ID for the current location (as identified in steps 40 and 41), as well as the time and day that the device was detected.

After new data records 60 and 68 are stored for the detected device, the process of FIG. 3 determines whether to trigger an alert for the new device (step 44). An alert is triggered if the alert settings were initialized to issue an alert for all new devices or for new devices at the current location, day and/or time. This decision may be based on the class of the location or the time of day. For example, new devices detected may always trigger an alert at a “home” class location, but not at a “workplace” class location, depending upon user selections.

If the conditions warrant an alert for the new device, then an alert is issued (step 45). Upon issuance of an alert, the user may be prompted with the known information about the location and device, and allowed to revise the location name 80 or classification 82 for the current location, or to add or change a name 64 or security class 66 for the detected device. After an alert (if any) is issued, and any user input is received and stored in memory, the process returns to monitoring for additional Devices at step 38.

The monitoring process described herein can include a form of automatic memory management for maintaining the size and efficiency of the illustrated data structure. One example of a memory management process would reduce each of the counters in field 72 by one in a periodic manner. A data record 68 reaching a count of zero would be removed from the database. Another example of a memory management process would include time stamping each of the data records 68 at the time the record is created. Data records exceeding a given age would be deleted in a cyclic process. The data deletion cycle time can be selected by the user during initialization or preset in the application software.

Additional data records or data structures could be implemented, consistent with principles of the present invention. For example, a log record could be built that logs each detection event, the location thereof, the identity of the detected device, whether an alert was generated, and other details. As the process of FIG. 3 monitors for new devices, the disappearance of devices that were previously detected could be noted, and logged, so that the log reflects the duration of time that a device was detected. This could be useful for evaluating, at a later time, the nature of the interaction with a detected device and to search for anomalies. A brief detection of an unknown device occurring at a private location such as a home, has a different character and possible meaning than a repeated, lengthy detection of a device, which is either indicative of a family member or possible stalker.

As described herein, a software application may be executed on a mobile device to allow a user to implement the monitoring process described herein, or in a fix location device. The device itself may allow a user to set user preferences to the monitoring process, or it may have an interface via a global or local area computer network, or personal area network, to display information and permit a user to set preferences.

As is to be appreciated, the application described herein may be structured in a number of ways. In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed:

1. A system for using a monitoring device to detect notable behavior of another person using unique identification information, the system comprising:
a monitoring device for monitoring for and capturing unique identification information of one or more monitored persons and/or mobile devices;
a memory in the monitoring device; and
a processor in the monitoring device for associating the unique identification information of the monitored person and/or mobile device with a current location, day and/or time of day, and storing the unique identification information and associated location, day and/or time of day in the memory,
the processor including logic for determining whether there is any previously stored data in the memory associating the captured unique identification information of the monitored person and/or mobile device with a location, day and/or time, and triggering an alarm based upon the match, or lack of a match, of a current location, day and/or time with the previously stored data associated with the unique identification information of the monitored person and/or mobile device.

2. The system of claim 1 wherein the monitoring device is a smartphone having an operating system, the processor being programmed to implement the smartphone as a monitoring device using application software running on the operating system.

3. The system of claim 1 further comprising geospatial locating means for determining a current location of the monitoring device.

4. The system of claim 1 wherein the monitoring device comprises a cellular traffic monitor, the cellular traffic monitor capturing an IMEI identifier for cellular telephone devices near to the monitoring device.

5. The system of claim 1 wherein the monitoring device comprises a Bluetooth® radio, the Bluetooth® radio capturing a Bluetooth® MAC address for a Bluetooth® enabled device near to the monitoring device.

6. The system of claim 1 wherein the monitoring device comprises a WiFi radio, the WiFi radio capturing a WiFi MAC address for a WiFi enabled device near to the monitoring device.

7. The system of claim 1 wherein the monitoring device comprises a near field communication radio, the near field communication radio capturing a NFC MAC address for a NFC enabled device near to the monitoring device.

8. The system of claim 1 wherein the monitoring device comprises a body recognition system, the body recognition system capturing biometric information for use as unique identification information of a monitored person.

9. The system of claim 8 wherein the biometric information comprises facial recognition information.

10. The system of claim 1 wherein the processor logic triggers a new person and/or device alarm when there is no previously stored data for the unique identification information of a monitored person and/or mobile device.

11. The system of claim 10 wherein the logic triggers said new person and/or device alarm only if the current location is designated in said memory to generate alarms upon detection of all new monitored persons and/or mobile devices.

12. The system of claim 1 wherein the processor logic triggers a frequent detection alarm when the previously stored data for the unique identification information of a monitored person and/or mobile device indicates greater than a threshold number of detections of the monitored person and/or mobile device.

13. The system of claim 12 wherein the processor logic triggers said frequent detection alarm only if the current location or the unique identification information of the monitored person and/or mobile device are designated in said memory to generate alarms upon greater than a threshold number of detections of a monitored person and/or mobile device.

14. The system of claim 1 wherein the processor logic triggers a new location alarm when there is no previously stored data for the unique identification information of a monitored person and/or mobile device at a current location.

15. The system of claim 14 wherein the processor logic triggers said new location alarm only if the current location or the unique identification information of the monitored person and/or mobile device are designated in said memory to generate alarms upon detection of a monitored person and/or mobile device at a new location.

16. The system of claim 1 wherein the processor logic triggers a new day/time alarm when there is no previously stored data for the unique identification information of a monitored person and/or mobile device for a current day/time.

17. The system of claim 14 wherein the processor logic triggers said new day/time alarm only if the current location or the unique identification information of the monitored person and/or mobile device are designated in said memory to generate alarms upon detection of a monitored person and/or mobile device at a new day/time.

18. A method of using a monitoring device to detect notable behavior of another person, the method comprising:
using a monitoring device to monitor for and capture unique identification information from one or more monitored persons and/or mobile devices;
associating the unique identification information of the monitored person and/or mobile device with a current location, day and/or time of day, and storing the unique identification information and associated location, day and/or time of day in a memory associated with the monitoring device;
comparing captured unique identification information from a monitored person and/or mobile device with prior stored unique identification information and associated locations, day and/or time information, to identify prior detections, or the lack of prior detections, of the unique identification information at a current location, day and/or time; and
triggering an alarm based upon the match, or lack of a match, of a current location, day and/or time with the previously stored data associated with the unique identification information of the person and/or monitored mobile device.
